(19) United States
(12) Patent Application Publication
(10) Pub. No.: US 2023/0001292 A1
(43) Pub. Date: Jan. 5, 2023

(54) PLAY SET

(71) Applicant: Julien GOULOIS, Sannois (FR)

(72) Inventor: Julien GOULOIS, Sannois (FR)

(21) Appl. No.: 17/782,204

(22) PCT Filed: Nov. 19, 2020
(86) PCT No.: PCT/EP2020/082764

§ 371 Date: Jun. 3, 2022

(30) Foreign Application Priority Data
Dec. 3, 2019 (FR) 1913663

(51) Int. Cl. A63F 13/245; A63F 13/235

(52) U.S. Cl. CPC A63F 13/245; A63F 13/235; A63F 2300/1031; A63F 2300/1043; A63F 2300/1062

(57) ABSTRACT

The invention concerns a play set having a play module with a play element and a base equipped with an electronic board having a communicator. The invention also includes an electronic reader for connection to a terminal allowing access to at least one computer platform providing at least one service. The electronic reader is arranged to connect the play module to the terminal by interaction with the communicator of the electronic board, in order to be able to use a function offered by the play element in the service provided by the computer platform. The play module further has a spherical matrix in which the play element and the base are enclosed, the spherical matrix allowing the play module to be used as a play ball.

### CROSS-REFERENCE TO RELATED APPLICATIONS

This application claims the benefit of International application number PCT/EP2020/082764, filed Nov. 19, 2020 and French patent application number 1913663, filed on Dec. 3, 2019, the entire contents of which are incorporated herein by reference.

### TECHNICAL FIELD

The invention relates to a play set.

### BACKGROUND

It applies in particular to play sets comprising:
at least one play module comprising a play element and a base over which said play element is mounted, said base being equipped with an electronic board comprising communication means;
an electronic reader comprising means for connection to a terminal enabling access to at least one computer platform for providing at least one service, said reader being arranged to connect the play module to said terminal by interaction with the communication means of the electronic board, in order to be able to use a function offered by said play element in the service provided by said computer platform.

Play sets are known wherein:
the play element is in the form of a figurine representing a character, in particular a cartoon and/or video game character;
the terminal, which may be a home game console, a mobile console or a computer, provides access to a computer platform enabling access to video game services, in particular by introducing into said terminal a medium corresponding to a given video game, for example of the CD-ROM (standing for Compact Disc Read Only Memory) type.

In particular, there are play sets wherein the electronic reader comprises a support equipped with means for connection to the terminal, for example means for wired connection of the USB (standing for Universal Serial Bus) type or means for wireless connection of the Wi-Fi or Bluetooth type, said support comprising an upper platform over which a play module is intended to be disposed to enable connection thereof to the terminal, in order to be able to play the character represented by the figurine in a compatible video game.

There are also play sets wherein the electronic reader comprises a chip, in particular of the NFC (standing for Near Field Communication) type, which is integrated into a mobile game console, in particular at its screen and/or its interactive keys, the user of said game console placing the base of the play module of his choice over the area where said chip is located to be able to:
play the character represented by the figurine of said play module in a compatible video game; and/or
use other types of functions offered by said figurine in a compatible video game, for example a bonus weapon for his character in said video game, an unprecedented object, a suit and/or an ornament, a music, a level and/or a hidden puzzle.

### SUMMARY OF THE INVENTION

The invention aims to enhance the prior art by providing a play set which offers other possibilities of games for its user, in order to be able to enrich the play experience of said user.

To this end, the invention provides a play set comprising:
at least one play module comprising a play element and a base over which said play element is mounted, said base being equipped with an electronic board comprising communication means;
an electronic reader comprising means for connection to a terminal enabling access to at least one computer platform for providing at least one service, said reader being arranged to connect the play module to said terminal by interaction with the communication means of the electronic board, in order to be able to use a function offered by said play element in the service provided by said computer platform;

the play module further comprising a spherical matrix in which the play element and the base are enclosed, said spherical matrix allowing using said play module as a play ball.

### BRIEF DESCRIPTION OF THE DRAWINGS

Other particularities and advantages of the invention will appear in the following description, made with reference to the appended figures, wherein:

FIG. 1a and FIG. 1b schematically represent a play module of a play set according to the invention, respectively in front view (FIG. 1a) and in bottom view (FIG. 1b);

FIG. 2 schematically shows in longitudinal section the base of the play module of FIGS. 1a and 1b;

FIG. 3 schematically represents an architecture comprising a play set according to the invention for interacting with at least one computer platform, in order to be able to use a function offered by the play module in one of the services provided by said platform;

FIG. 4 schematically represents a particular case of the architecture of FIG. 3, in which the play module of FIGS. 1a and 1b is connected to the electronic reader to access a computer platform via a smartphone-type mobile terminal;

FIG. 5 schematically represents in perspective front view a play board of a play set according to the invention;

FIG. 6a and FIG. 6b schematically represent the target of the play board of FIG. 5, respectively in longitudinal section (FIG. 6a) and in top view (FIG. 6b);

FIG. 7a and FIG. 7b schematically represent a side view of a play board of a play set according to the invention, respectively in the folded storage position (FIG. 7a) and in the deployed use position (FIG. 7b);

FIG. 8 schematically represents the display on a terminal of a service provided by a computer platform, in which each of two users of said service uses a function offered by their respective play modules.

### DETAILED DESCRIPTION

A play set is described hereinbelow with reference to these figures.

The play set comprises at least one play module 1, said module comprising a play element 2 and a base 3 over which said play element is mounted.

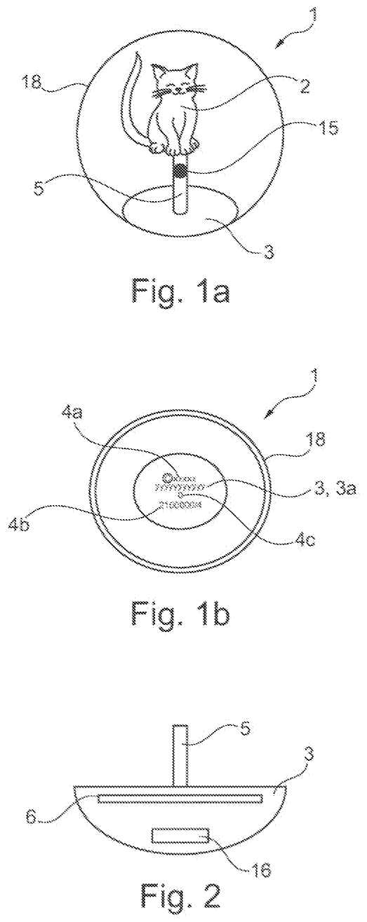

The play element 2 may be in the form of a figurine representing a character, for example a human being or an animal, as represented in FIG. 1a.

The character may be a known imaginary character, for example a character of a comic strip, a film, a cartoon and/or a video game, or a known real personality, for example in the sports or entertainment field. The figurine 2 may also be customised for the user of the play module 1, for example by representing the user himself.

The play element 2 may also represent an object or an abstract shape. In particular, the play element may represent a real object, for example a football or basketball ball, or a cup of a sporting event, or a known symbolic object, for example an emblematic object of a fiction work and/or a cultural legend. The play element 2 may also represent an ornament, for example with transparent bubbles and/or sequins, or a shape inspired by a meteorological or astral phenomenon, such as an aurora borealis, a constellation and/or a planet.

Advantageously, the play element 2 is made by 2D or 3D printing, which allows improving its aesthetic appearance, and thus inciting a user to use the play module 1 as a decorative object and/or to collect different play modules 1.

As represented in FIG. 1b, the base 3 comprises a lower face 3a on which at least one inscription 4a, 4b is formed. In particular, the base 3 may comprise a textual inscription 4a specifying the cultural license (cartoon, comic strip, video game) to which the play element 2 belongs, and/or an alphanumeric inscription 4b relating to a serial number of the play module 1.

In the represented embodiment, the play element 2 is mounted over the base 3 via a foot 5. Advantageously, the foot 5 is made of a transparent material, which allows limiting its visibility, and thus improving the aesthetic appearance of the play module 1.

The base 3 is equipped with an electronic board 6 comprising communication means, for example according to the radio-identification RFID (standing for Radio Frequency Identification) protocol, or according to the NFC (Near Field Communication) protocol. In particular, the electronic board 6 may be an NFC board compliant with the ISO 14443 A standard.

The play set further comprises an electronic reader 7 which comprises means 8a, 8b for connection to a terminal 9a, 9b, 9c, 9d for accessing at least one computer platform 10 for providing at least one service 11.

The terminal may be a home game console 9a connected to a television set 12, a mobile game console 9b, a smartphone 9c, a touch tablet, a personal computer 9d, or else a laptop.

The computer platforms 10 may be operating systems specific to a game console 9a, 9b and/or online sites of commercial entities accessible via a fixed 9d and/or mobile 9c terminal, and may in particular provide video game services 11 and/or online product purchase services. In particular, the terminal 9a, 9b, 9c, 9d may comprise means for communication with an online computer network 13, in particular the Internet.

The electronic reader 7 is arranged to connect the play module 1 to the terminal 9a, 9b, 9c, 9d by interaction with the communication means of the electronic board 6, in order to be able to use a function offered by the play element 2 in a service 11 provided by the computer platform 10.

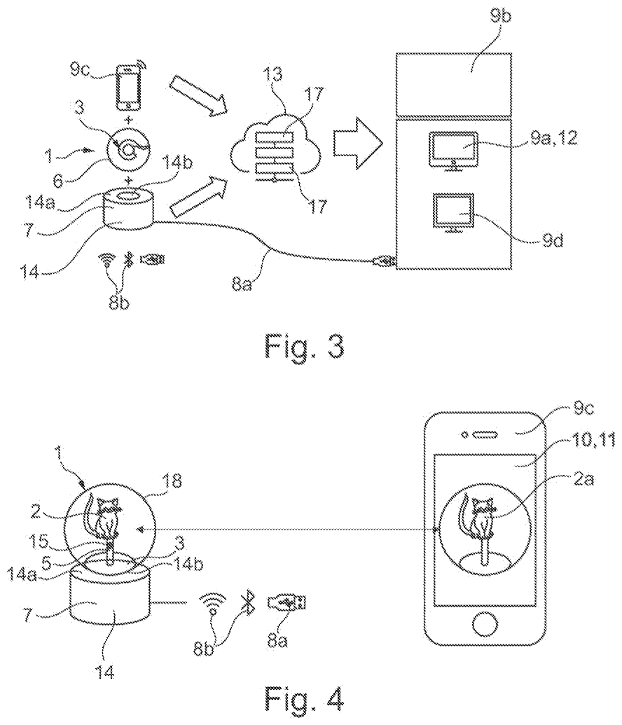

In the embodiment represented in FIGS. 3 and 4, the electronic reader 7 comprises a support 14 equipped with means for connection to the terminal 9a, 9b, 9c, 9d, in particular via a wired connection 8a, for example of the USB (Universal Serial Bus) type, and/or a wireless connection 8b, for example of the Wi-Fi or Bluetooth type.

In a non-represented variant, the electronic reader 7 may comprise a chip, in particular of the NFC type, which is integrated into a mobile terminal, for example a smartphone 9c, a touch tablet, a mobile game console 9b or a gamepad of a home game console 9a. In particular, the mobile terminal 9b, 9c may:
serve as an intermediary to access the computer platform 10, in particular thanks to means for connection to another terminal providing access to said platform; or
enable the user to directly access said platform, by being equipped with suitable means.

The support 14 comprises an upper platform 14a over which a play module 1 is intended to be disposed while enabling said play module to be connected to the terminal 9a, 9b, 9c, 9d. For this purpose, the upper platform 14a comprises a central housing 14b in which the base 3 of the play module 1 is intended to be disposed.

The electronic reader 7 comprises means for interacting with the electronic board 6, for example an NFC card, in order to connect the play module 1 to the terminal 9a, 9b, 9c, 9d. In particular, the electronic board 6 of the play module 1 may comprise storage means in which an identifier of the play element 2 is recorded, the electronic reader 7 comprising means for collecting this identifier and transmitting it to the terminal 9a, 9b, 9c, 9d.

Advantageously, the support 14 and/or the base 3 comprises lighting means 15, as well as a switch 16 arranged to activate said lighting means upon mounting of a play module 1 over the support 14, in order to enable lighting of the play element 2 in said play module.

Thus, the user is provided with a visual indicator to indicate that the connection of the play module 1 to the support 14 is effective. Moreover, the lighting means 15 may be arranged to give an advantageous aesthetic effect on the play module 1 during use thereof, in particular by showcasing the play element 2 that it contains.

The lighting means may comprise an optical fibre 15 mounted at least partially in the foot 5 supporting the play element 2, in order to light up the play element 2 from outside. Alternatively, the optical fibre 15 may protrude inside the play element 2, which may be made of a partially translucent material in order to be able to be lit up from the inside.

The lighting means may also comprise a series of light-emitting diodes (LEDs) disposed in the housing 14a for receiving the play module 1, said diodes being arranged to light up the play element 2 with coloured lights.

Referring to FIG. 2, the base 3 comprises a magnet 16, and the support 14 comprises a switch, for example of the N/C SPDT type, which is arranged to interact with said magnet upon mounting of said play module on said support, in order to activate the lighting means 15.

Once the play module 1 is connected to the terminal 9a, 9b, 9c, 9d, the user could use a function offered by the play element 2 in a service 11 provided by a computer platform 10 accessible from said terminal.

For this purpose, the terminal 9a, 9b, 9c, 9d may display a request to ask the user to select a computer platform 10 of his choice, then to transmit the identifier of the play element 2 to the selected computer platform 10.

The computer platforms 10 may be connected to at least one server 17 via a computer network 13, for example the Internet, said server comprising at least one database in which the identifiers of the different existing play elements 2 are recorded, as well as the functions offered by these play elements 2 in different services 11 accessible by said computer platforms.

The database may be updated with new play elements 2, new computer platforms 10 compatible with the play set, and/or new services 11 available on at least one computer platform 10.

Thus, when an entity, in particular a game console production company, a video game edition company or an online sale company, wishes to develop an offer compatible with the play set, it could register its platform computer 10 in a dedicated server 17, as well as the services 11 accessible by said platform that it wishes to make compatible with said play set.

Similarly, when new play modules 1 are developed, the identifiers of their play elements 2 may be recorded in a dedicated server 17, said server being updated to associate new functions to said identifiers, according to the interested entities and/or or the services 11 offered by said entities.

At least one computer platform 10 may provide a video game service 11, at least one play module 1 comprising a play element 2 offering an aesthetic, interactive and/or musical function compatible with said video game.

In particular, in the case where the play element 2 is in the form of a figurine representing a character, said play element may offer a function allowing playing an avatar 2a of said character in the video game 11.

The play element 2 may also offer other functions in the video game 11, in particular related to the cultural license to which it belongs. For example, the play element 2 may enable the user to have a weapon and/or a particular bonus object(s), to change the appearance of his character in the video game 11, to listen to a particular musical piece during his play, or to access a hidden level.

Moreover, at least one computer platform 10 may provide a service offering price discounts and/or gifts for the purchase of products, at least one play module 1 comprising a play element 2 offering a function enabling the use of at least one of said discounts and/or one of said gifts.

For example, the play element 2 may enable the user to benefit from promotional codes for the possible purchase of other products related to the cultural license to which said play element belongs. For example, if the play element 2 represents a character or an emblematic object of the video game 11, the offered function may be a price discount upon the subsequent purchase of a derivative product of said video game in a partner online or physical store, or a ticket offered to attend an event organised around said video game.

The play element 2 may also offer functions indirectly related to the aesthetic theme of said play element. Thus, if the play element 2 represents a character playing a musical instrument, it may provide a function such as:
the offer of a course to learn to play said instrument;
a price discount upon purchase of said instrument or an accessory related to said instrument;
a price discount for the purchase of a concert or a particular musical or cultural event ticket.

The play module 1 further comprises a spherical matrix 18 in which the play element 2 and the base 3 are enclosed, said spherical matrix enabling to use said play module as a play ball.

Thus, the playful experience of the user is enriched, in particular by enabling him to exchange his play modules 1 with other users in a funny way, in order to be able to complete his collection.

The play modules 1 may be produced in different quantities, and a rarity value may be assigned to them inversely proportional to the total number of copies produced for each of said play modules. In particular, the number and/or the market value of the functions offered by the play element 2 may be proportional to the rarity value of the play module 1, in order to encourage the user to acquire and collect the rarest play modules 1.

Referring to FIG. 1b, the lower face 3a of the base 3 may comprise an inscription 4c indicating the rarity value of the play module 1, for example with a numerical value.

The matrix 18 is made of a transparent or translucent, optionally coloured, material. In particular, to limit the risk of break-up, in particular during the use of the play module 1 as a play ball, the matrix 18 is made of a plastic material, for example based on poly(methyl methacrylate) (PMMA) and/or polylactic acid (PLA).

To improve the rolling stability of the play module 1, the matrix 18 may be filled with a liquid or solid material which is at least translucent. Furthermore, decorative elements, for example sequins and/or transparent bubbles, may be disposed suspended in the filling material of the matrix 18, in order to showcase the play element 2.

The base 3 is made of a monochrome material, whose density is arranged to enable the play module 1 to roll in a balanced manner when it is used as a play ball.

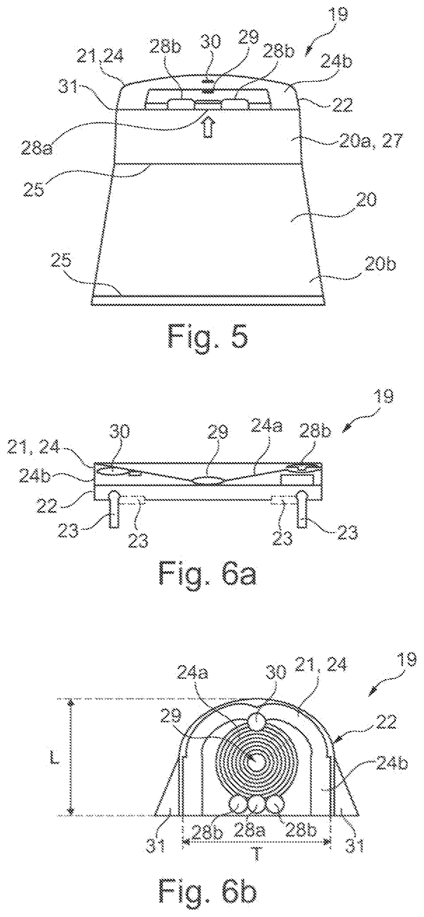

Referring to FIGS. 5, 6a, 6b, 7a and 7b, the play set further comprises a play board 19 to be able to use the play modules 1 as play balls. The play board 19 has a track 20 at the end of which a target 21 is disposed, said track being arranged to enable at least two users to each make at least one play module 1 roll therein in an attempt to reach said target.

In the represented embodiment, the play board 19 comprises a case 22 under which four feet 23 are formed intended to be disposed bearing on the ground, said case comprising a substantially horizontal upper platform 24 on which the target 21 is formed.

Advantageously, the track 20 is movable between a storage position, in which it is wound around the case 22, and a use position, in which it is deployed upstream of the target 21, which allows limiting the bulk of the play board 19 when it is not used, but also facilitating transport thereof.

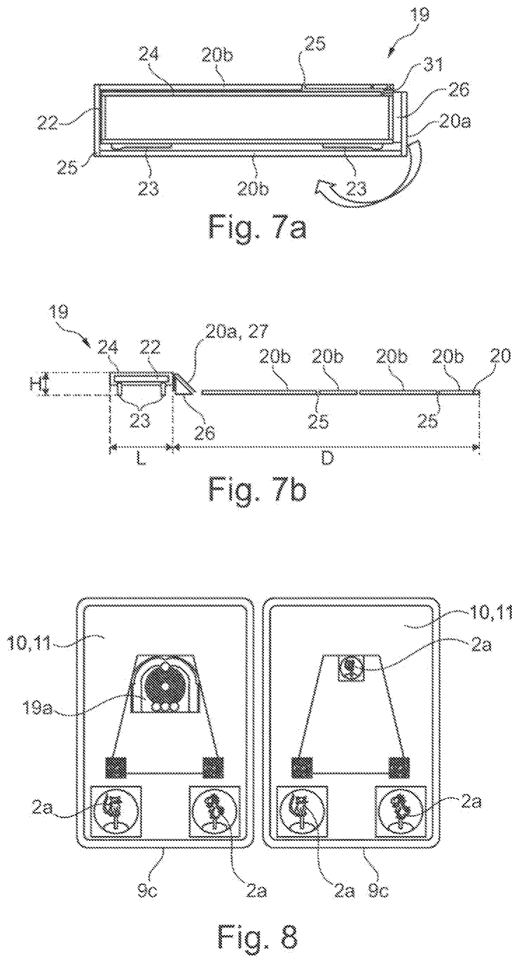

Furthermore, as represented in FIG. 7a and in dotted lines in FIG. 6a, the feet 23 may be arranged to be folded under the case 22 before folding of the track 20 around said case.

In FIGS. 7a and 7b, the track 20 is formed by five substantially rectangular panels 20a, 20b, for example based on felt, said panels being connected in pairs by a transverse fold line 25 and having dimensions arranged to enable the total coverage of the case 22 by said track in the storage position.

Moreover, the proximal panel 20a of the track 20 is equipped with a reinforcing element 26 which is associated under the lower face of said proximal panel, said reinforcing element being arranged:
in the storage position, to be folded between said proximal panel and a lateral face of the case 22 (FIG. 7a); and
in the use position, to be deployed under said proximal panel so as to bear on the ground while orienting said proximal panel according to an oblique direction with respect to the upper platform 24, in order to form a ramp 27 for accessing said platform.

The case 22 has:
a height H in the range of 6 centimetres, when the feet 23 are unfolded;
a longitudinal dimension L comprised between 20 cm and 25 cm;
a transverse dimension T in the range of 30 cm.

Moreover, the track 20 in the deployed position has a transverse dimension equal to the transverse dimension T of the case, as well as a total longitudinal dimension D in the range of 115 cm, the respective longitudinal dimensions of the ramp 27 and of the upstream portion of the track 20 being respectively 15 cm and 100 cm.

At least one orifice 28a, 28b, 29, 30 is formed in the upper platform 24, said orifice being arranged, in particular by its shape and its dimensions, to enable the passage of a play module 1 therethrough.

Referring to FIGS. 5, 6a and 6b, the upper platform 24 comprises:
three upstream orifices 28a, 28b aligned along the fold line 31 formed between the target 21 and the ramp 27;
a central orifice 29 disposed substantially at the centre of the target 21; and
a downstream orifice 30 disposed at the bottom of the target 21.

In particular, the platform 24 has at least one recessed or raised pattern to enable guidance of a play module 1 towards one of the orifices 28a, 28b, 29, 30. In the represented embodiment, the platform 24 has a substantially circular central area 24a which forms a depression at the bottom of which the central orifice 29 is disposed, as well as a peripheral gutter 24b with a curved geometry which extends along the edges of said target, the downstream orifice 30 being disposed at the apex of said curve.

Each orifice 28a, 28b, 29, 30 is equipped with lighting means arranged to be activated when a play module 1 passes throughout said orifice, in order to provide visual information relating to a score of the user of said play module.

For this purpose, the base 3 and/or the orifice 28a, 28b, 29, 30 may comprise a switch arranged to activate the lighting means of said orifice upon passage of said play module throughout said orifice. In particular, the orifice 28a, 28b, 29, 30 may be equipped with a switch arranged to interact with the magnet 16 of the base 3.

The orifices 28a, 28b, 29, 30 may give the user a different number of points, depending on the difficulty of making a play module 1 pass therein. Thus, the more an orifice 28a, 28b, 29, 30 is difficult to reach, the more the user scores points.

Furthermore, the rarity value of the play module(s) 1 used during a play may be added to the final score of their user at the end of said play, in order to give an advantage to the users playing play modules 1 with high rarity values.

For example, the central upstream orifice 28a may be equipped with lighting means arranged to emit a white light, in order to indicate to the user of the play module 1 that he has just scored 50 points. Similarly, each lateral upstream orifice 28b may be equipped with lighting means arranged to emit a red light, in order to indicate to the user that he has scored 25 points.

Advantageously, some orifices 29, 30 may be equipped with lighting means arranged to be activated according to several lighting modes each corresponding to a particular score information, said orifices further comprising means for randomly activating the lighting means according to one of said modes upon passage of a play module 1 throughout said orifices.

Thus, the central orifice 29 may comprise:
a “10 points” mode, in which the lighting means do not light up, the user of the play module 1 scoring 10 points;
a “50 points” mode, in which the lighting means emit a white light, the user of the play module 1 scoring 50 points;
a “100 points” mode, in which the lighting means emit a blue light, the user of the play module 1 scoring 100 points;
an “Eliminated” mode, in which the lighting means emit a yellow light, the user of the play module 1 being eliminated from the current play.

Similarly, the downstream orifice 30 may comprise:
a “100 points” mode, in which the lighting means do not light up, the user of the play module 1 scoring 100 points;
a “Winner” mode, in which the lighting means emit a blue light, the user of the play module 1 automatically winning the current play.

As represented in FIG. 6b, the case 22 comprises two bellows 31 disposed on each of its sides, in order to enable a manual recovery of all play modules 1 having passed throughout the orifices 28a, 28b, 29, 30 at the end of a play.

In particular, as represented in FIG. 8, at least one computer platform 10 provides an online video game service 11 incorporating the principles of the play board 19, in order to enable users to play the avatars 2a of their play modules 1 on a virtual play board 19a.

What is claimed is:

1. A play set comprising:
a play module comprising a play element and a base over which the play element is mounted, the base being equipped with an electronic board comprising a communicator;
an electronic reader comprising a connector connected to a terminal enabling access to a computer platform for providing a service, the electronic reader being arranged to connect the play module to the terminal by interaction with the communicator of the electronic board, to use a function offered by the play element in the service provided by the computer platform;
the play set wherein the play module further comprises a spherical matrix in which the play element and the base are enclosed, the spherical matrix being configured as a play ball.

2. The play set according to claim 1, wherein the computer platform provides access to a video game service, the play element offering an aesthetic, interactive or musical function compatible with a video game provided by the video game service.

3. The play set according to claim 2, wherein the play element is a figurine representing a character, the play element offering a function allowing playing an avatar of the character in the video game.

4. The play set according to claim 1, wherein the computer platform provides access to a service offering price discounts or gifts for the purchase of products the play element offering a function allowing use of a price discount or one of a gift for the purchase of product.

5. The play set according to claim 1, wherein the electronic reader comprises a support equipped with the connector for connection to the terminal, the support comprising an upper platform on which a play module is disposed while enabling the connection of the play module to the terminal.

6. The play set according to claim 5, wherein the support or the base comprises a light and a switch configured to activate the light upon mounting of a play module on the support to light the play element in the play module.

7. The play set according to claim 6, wherein the base comprises a magnet, the support comprising a switch configured to interact with the magnet in order to activate the light.

8. The play set according to claim 1 wherein the electronic reader comprises a chip which is integrated into a mobile terminal, the mobile terminal comprising a connector connected to a terminal for accessing the electronic.

9. The play set according to claim 1, further comprising a play board having a track at the end of which a target is disposed, the track being configured to enable at least two users to each make at least one play module roll therein in an attempt to reach the target, the target comprising a substantially horizontal platform in which is formed an orifice configured to enable passage of a play module therethrough, the orifice being equipped with a light configured to be activated upon passage of a play module through the orifice, and provide visual information relating to a score of the user of the play module.

10. The play set according to claim 9, wherein the base or the orifice comprises a switch configured to activate the light for lighting the orifice upon passage of the play module through the orifice.

11. The play set according to claim 9, wherein the light is configured to be activated according to several lighting modes, each corresponding to a particular score information, the orifice further configured to randomly activate the light according to one of the lighting modes upon passage of a play module through the orifice.

12. The play set according to claim 9, wherein the track is movable between a storage position, in which the track is wound around the target, and a use position, in which the track is deployed upstream of the target.
